(19) United States
(12) Patent Application Publication
(10) Pub. No.: US 2025/0280273 A1
(43) Pub. Date: Sep. 4, 2025

(54) NAVIGATION INFORMATION RECEPTION DEVICE, NAVIGATION INFORMATION TRANSMISSION DEVICE, NAVIGATION INFORMATION TRANSMISSION AND RECEPTION SYSTEM, NAVIGATION INFORMATION RECEPTION METHOD, AND NAVIGATION INFORMATION TRANSMISSION METHOD

(71) Applicant: FURUNO ELECTRONIC CO., LTD., Hyogo (JP)

(72) Inventor: Takayuki YAMASAKI, Hyogo (JP)

(73) Assignee: FURUNO ELECTRONIC CO., LTD., Hyogo (JP)

(21) Appl. No.: 19/209,776

(22) Filed: May 15, 2025

Related U.S. Application Data
(63) Continuation of application No. PCT/JP2024/004353, filed on Feb. 8, 2024.

(30) Foreign Application Priority Data
Feb. 21, 2023 (JP) 2023-025104

(51) Int. Cl. H04W 4/40; G01C 21/20

(52) U.S. Cl. CPC H04W 4/40; G01C 21/203

(57) ABSTRACT

A navigation information reception device includes: a reception part configured to receive a navigation information message; a determination part configured to determine whether the received navigation information message is a format message or a non-format message; a format storage part configured to store format information included in the navigation information message in a case where the received navigation information message is determined to be the format message; and an analysis part configured to analyze content of the navigation information message based on the stored format information in a case where the received navigation information message is determined to be the non-format message and where the format information is stored.

### CROSS-REFERENCE TO RELATED APPLICATION

This application is a continuation of PCT International Application No. PCT/JP2024/004353, filed on Feb. 8, 2024, which claims priority under 35 U.S.C § 119(a) to Japanese Patent Application No. 2023-025104, filed on Feb. 21, 2023. Each of the above application(s) is hereby expressly incorporated by reference, in its entirety, into the present application.

### BACKGROUND

### Technical Field

The disclosure relates to transmission and reception of navigation information, particularly to a format for transmission and reception of navigation information.

### Conventional Art

In AIS (automatic identification system for ships) messages, one of the messages for transmitting and receiving navigation information, a message type called a binary message type is defined, and formats are defined for each region, allowing for individual operations by region.

### CITATION LIST

### Patent Document

### [Non-Patent Document 1] IEC 61993-2:2012 Standard Maritime Navigation and Radio Communication Equipment and Systems—Part2

However, for example, in the case of individual operation of binary messages in AIS messages, if the format of binary messages included in AIS messages is changed, it is necessary to update the software to correspond to the new format. In addition, users need to introduce equipment that corresponds to the new format, and cannot start operation with the new format until the equipment is introduced.

Therefore, the purpose of the disclosure relates to a technology that enables analysis of navigation information messages even in the case where the message format is changed, without requiring software or equipment updates.

### SUMMARY

The navigation information reception device of this disclosure includes a reception part configured to receive a navigation information message; a determination part configured to determine whether the received navigation information message is a format message or a non-format message; a format storage part configured to store format information included in the navigation information message in a case where the received navigation information message is determined to be the format message; and an analysis part configured to analyze content of the navigation information message based on the stored format information in a case where the received navigation information message is determined to be the non-format message and where the format information is stored.

In this configuration, if the message is a format message, it is stored as a format, and if it is a non-format message, it is analyzed as a navigation information message.

According to this disclosure, navigation information messages can be analyzed even in a case where the message format is changed, without requiring software or equipment updates.

### BRIEF DESCRIPTION OF THE DRAWINGS

FIG. 1 is a diagram showing an overview of message reception from a base station according to the first embodiment of the disclosure.

FIG. 2 is a diagram showing an example of a template for a binary message according to the first embodiment of the disclosure.

FIG. 3 is a diagram showing an example of a format according to the first embodiment of the disclosure.

FIG. 4 is a functional block diagram of an AIS reception device according to the first embodiment of the disclosure.

FIG. 5 is a functional block diagram of an AIS transmission device according to the first embodiment of the disclosure.

FIG. 6 is a flowchart at the time of reception of an AIS message according to the first embodiment of the disclosure.

FIG. 7 is a flowchart at the time of creation of an AIS message according to the first embodiment of the disclosure.

FIG. 8 is a diagram showing an overview of message reception from a ship according to the second embodiment of the disclosure.

FIG. 9 is a functional block diagram of an AIS reception device according to the third embodiment of the disclosure.

### DESCRIPTION OF THE EMBODIMENTS

### First Embodiment

The navigation information reception device, navigation information transmission device, and navigation information transmission and reception system according to the first embodiment of the disclosure will be described with reference to the figures. The following description applied to AIS, but it may also be applied to VDES (VHF Data Exchange System).

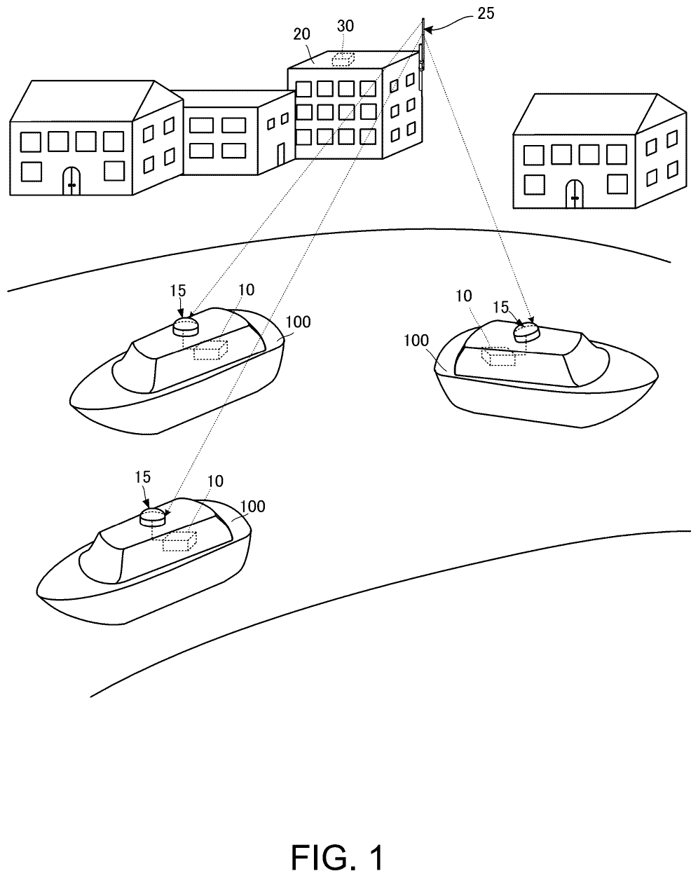

As shown in FIG. 1, an AIS system (navigation information transmission and reception system) includes an AIS transmission device (navigation information transmission device) 30 included in a base station 20, and an AIS reception device (navigation information reception device) 10 included in a waterborne vehicle (ship) 100. A waterborne vehicle 100 equipped with this AIS reception device 10 is a mobile station of the AIS system.

An AIS transmission device 30 creates an AIS message (navigation information message) and transmits it from an antenna 25 of the base station 20. The AIS reception device 10 receives the AIS message with an antenna 15. As a result, the waterborne vehicle 100 receives the AIS message from the base station 20.

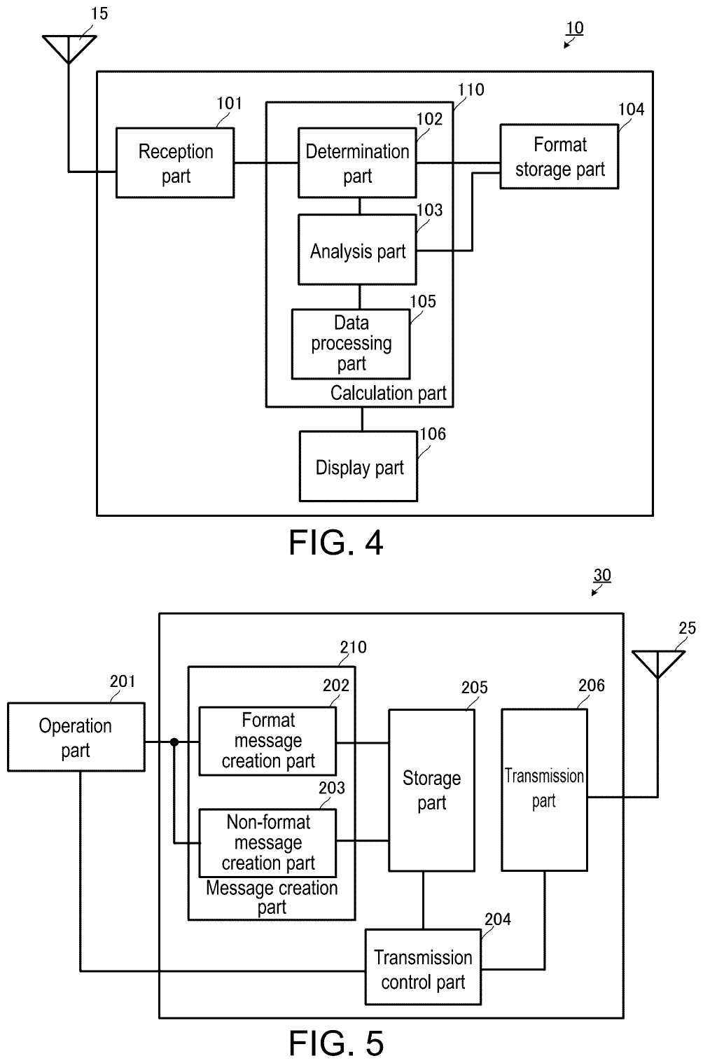

The reception of AIS messages will be described using FIG. 4. As shown in FIG. 4, the AIS reception device 10 includes a reception part 101, a calculation part 110, a format storage part 104, and a display part 106. The calculation part 110 includes a determination part 102, an analysis part 103, and a data processing part 105. In addition, the reception part 101 of the AIS reception device 10 is connected to the antenna 15.

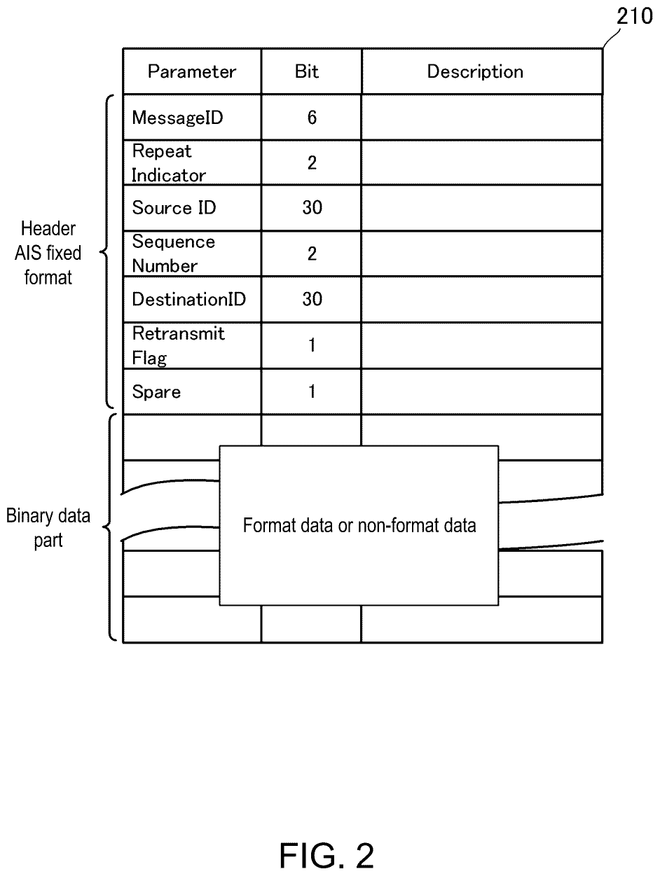

FIG. 2 shows an example of a template for a binary message among AIS messages. Binary messages are defined, for example, in ITU-RM1371 by AIS message types 6, 8, etc. The example shown is message type 6. A binary message includes a header and a binary data part. In the header, attributes of data are defined in advance, and parameters, number of bits, etc. are defined as shown in FIG. 2, for example.

The content of the binary data part is defined in various data formats defined by IMO and each region. Similarly, data attributes and other properties may be appropriately defined to exchange information. The binary data part may be configured as a format message or a non-format message.

A format message is a binary message that includes data (local data format data) defining a data format in a local or specific range in the binary data.

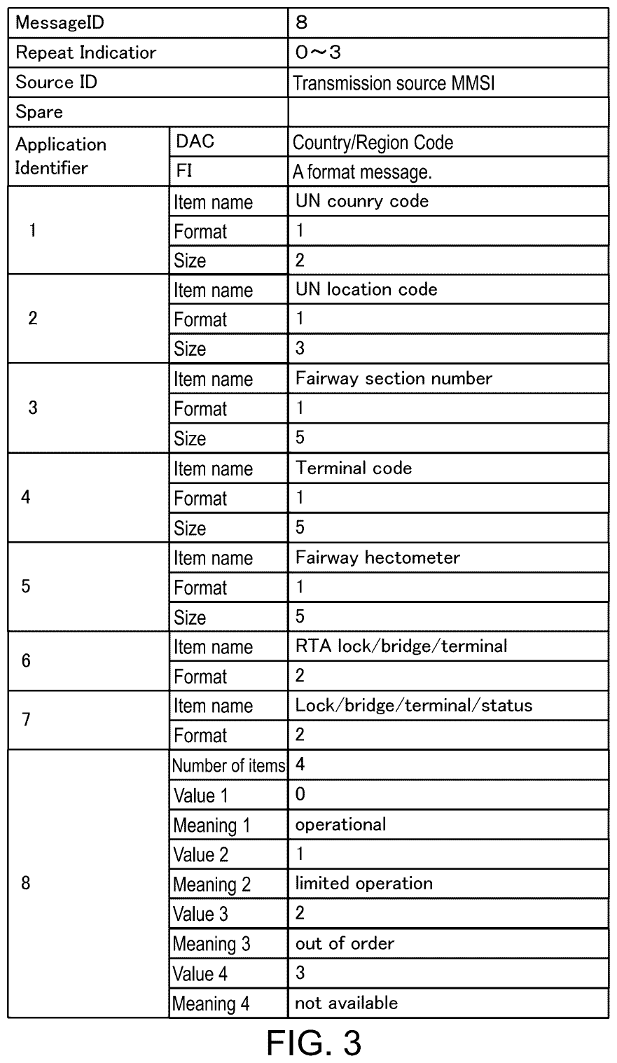

FIG. 3 shows an example of a format message. Here, the format of binary message type 8 is used. In the case of operating in a data format by region, it is possible to operate using identification symbols specific to DAC (Designated Area Code) and FI (Function ID). Moreover, a local data format is defined in the binary data. In the example of FIG. 3, the 8 data formats are defined. The example formats indicate 1 as string type and 2 as time type.

A non-format message is a binary message in which information is recorded in binary data using the defined local data format included in the format message.

The reception part 101 receives AIS messages via the antenna 15. The reception part 101 outputs the AIS messages to the determination part 102.

The determination part 102 determines whether the received AIS message is a binary message. Whether it is a binary message or not may be identified by a message identifier (message ID), etc. In the case of AIS messages other than binary messages, normal data processing is performed in the data processing part 105. In the case of a binary message, whether it is a format message or a non-format message is determined. This determination may be made by providing a flag in the header, etc. recorded in the binary data. Moreover, a specific number/symbol of FI in the header information may be defined as a format message and operated. In addition, an identification flag indicating whether the message is a format message or not may be set in the binary data. In the case where the determination part 102 determines that the AIS message is a format message, it stores the local data format (format information) included in the format message in the format storage part 104.

The analysis part 103 analyzes the content of the non-format message. At this time, the analysis part 103 uses the local data format stored in the format storage part 104 for analysis. In the case where the analysis is possible, the analysis part 103 displays the content of the non-format message on the display part 106. In addition, in the case where the analysis part 103 is unable to analyze the non-format message, an error message or the like may be displayed.

As a result, in the case of individually operating binary messages for each region, even if the format of the binary data is changed, the binary data may be analyzed with the changed format.

Moreover, only the reception of AIS messages is shown here, but in the case where the waterborne vehicle 100 performs transmission by AIS, binary data of AIS messages is creased using this local format.

The transmission of AIS messages will be described using FIG. 5. As shown in FIG. 5, the AIS transmission device 30 includes an operation part 201, a message creation part 210, a transmission control part 204, a storage part 205, and a transmission part 206. The message creation part 210 includes a format message creation part 202 and a non-format message creation part 203. In addition, the AIS transmission device 30 includes an antenna 25.

The operation part 201 receives operation inputs necessary for creating AIS messages. The message creation part 210 creates AIS messages according to the operation inputs. The format message creation part 202 creates format data according to the operation input of the operation part 201. The non-format message creation part 203 creates non-format data according to the operation input of the operation part 201.

The transmission control part 204 controls the transmission of AIS messages including binary messages, and conveys it on to the transmission part 206 for periodic or immediate transmission. The transmission part 206 transmits AIS messages via the antenna 25.

With this configuration, the AIS transmission device 30 transmits AIS messages including the created format messages or non-format messages.

In the case of creating a local data format, the user performs the operation of creating a local format from the operation part 201. The format message creation part 202 receives the instruction for format creation and calls up binary data of an AIS message, for example, as shown in FIG. 3. The user defines the local data format for the binary data using a template of the binary data by means of the operation part 201. The format message creation part 202 stores the local data format defined in the binary data in the storage part 205.

In the case of creating non-format data, the user performs the operation of creating non-format data from the operation part 201. The non-format message creation part 203 receives the instruction for non-format creation and calls up a template of binary data.

The user performs recording corresponding to the local data format using the template of binary data by means of the operation part 201. The non-format message creation part 203 stores the recorded binary data in the storage part 205. The creation of non-format data is not limited thereto, and the data may be created from scratch or automatically generated.

At the time of transmission of AIS messages, the transmission control part 204 searches for format messages or non-format messages from the storage part 205 according to the transmission timing.

At the transmission timing of format messages, the transmission control part 204 extracts the format message from the storage part 205, sets a flag indicating a format message in the header, and conveys it on to the transmission part 206. The transmission part 206 generates an AIS message including the format message and transmits it from the antenna 25.

Moreover, AIS messages including format messages are repeatedly transmitted at particular time intervals. As a result, even if reception fails once, the waterborne vehicle 100 may obtain the format message, enabling communication using the local data format.

At the transmission timing of non-format messages, the transmission control part 204 extracts the non-format message from the storage part 205, sets a flag indicating a non-format message in the header, and conveys it on to the transmission part 206. The transmission part 206 generates an AIS message including the non-format message and transmits it from the antenna 25. Moreover, the disclosure is not limited thereto; the message may be transmitted immediately.

Moreover, in the above description, a configuration in which multiple functional parts perform reception, analysis, and transmission of AIS messages is shown. However, the processing may be programmed and stored, and the program may be read and executed by a calculation processing device such as a computer.

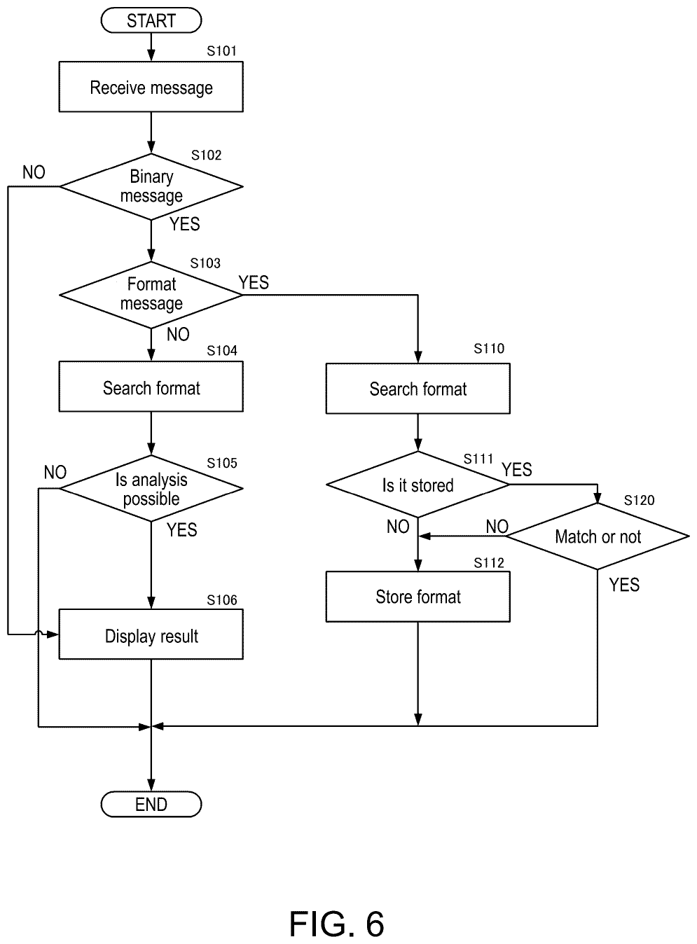

FIG. 6 is a flowchart showing a case where AIS messages is received according to the first embodiment of the disclosure.

The AIS reception device 10 receives an AIS message (S101). The AIS reception device 10 determines whether the received AIS message is a binary message or not (S102). In the case where the received AIS message is not a binary message (S102: No), normal message analysis processing is performed and the result is displayed. In the case where the received AIS message is a binary message (S102: Yes), whether or not the binary data of the received binary message is a format message (S103) is determined. In the case where the binary data of the binary message is a non-format message, that is, not a format message (S103: No), a search is performed to see if a corresponding local data format exists (S104).

The AIS reception device 10 analyzes the non-format message using the searched local data format and determines whether normal analysis is possible (S105). In the case where the non-format message may be analyzed (S105: Yes), the AIS reception device 10 displays the analysis result (S106).

In addition, in the case where the non-format message cannot be analyzed (S105: No), the AIS reception device 10 ends the processing. In this case, the AIS reception device 10 may also notify that analysis is not possible.

On the other hand, in the case where the binary message is a format message, that is, not a non-format message (S103: Yes), the AIS reception device 10 searches for a local data format (S110).

The AIS reception device 10 determines whether the local data format included in the received format message is stored (S111). In the case where the local data format is not stored (S111: No), the AIS reception device 10 stores the local data format (S112).

In the case where the local data format is already stored (S111: Yes), the AIS reception device 10 confirms whether the local data formats match or not (S120), and if they to (S120: Yes), the processing is ended.

If the local data formats do not match (S120: No), the AIS reception device 10 overwrites and stores the format. Alternatively, it may store the format anew without overwriting. In this case, management may be performed using timestamps or version information. By doing so, the AIS reception device may store the necessary local data format, and also store the latest local data format by storing it anew even when the local data format is updated, making it possible to analyze binary messages based on that local data format.

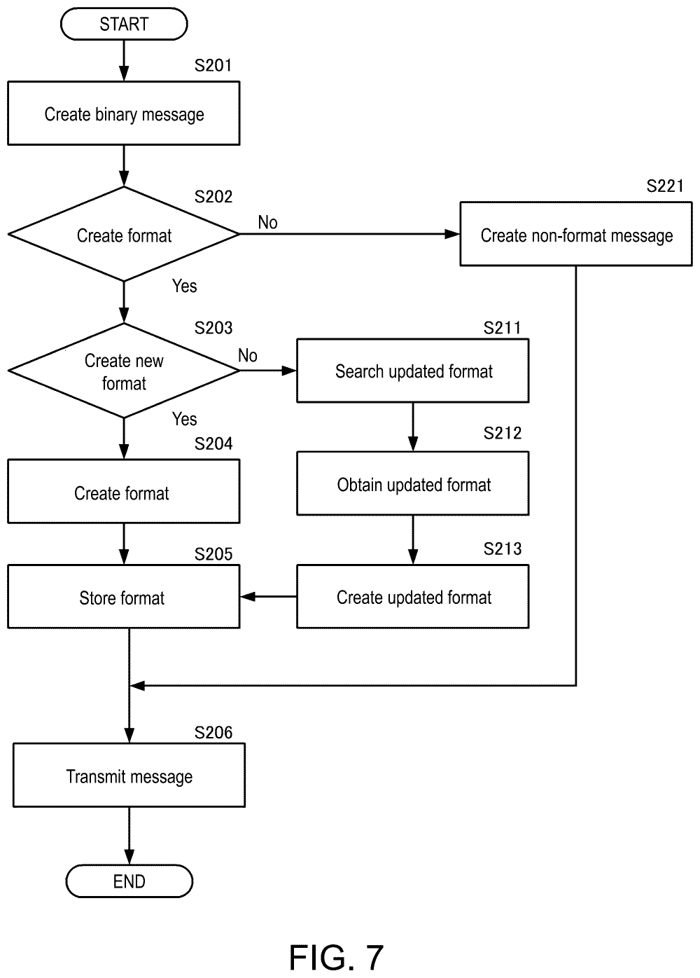

FIG. 7 is a flowchart showing a case where a binary message among AIS messages is created and transmitted according to the first embodiment of the disclosure.

The AIS transmission device 30 starts creating a binary message (S201). Next, based on user operation, whether the message to be created is a format message or a non-format message (S202) is determined. In the case of creating a format message (S202: Yes), the AIS transmission device 30 determines whether to create a new local data format (S203). In the case of creating a new local data format (S203: Yes), a format (S204) is created and the created format (S205) is stored. The AIS transmission device 30 transmits an AIS message that is a binary message including the stored local data format (S206).

In the case of creating a format message by updates and uses an existing local data format without creating a new format (S203: No), the AIS transmission device 30 searches for the corresponding existing local data format (S211). The AIS transmission device 30 obtains the existing local data format (S212). The AIS transmission device 30 updates and creates the local data format by updating a part of the existing local data format (S213). Then, it stores the created format (S205). The AIS transmission device 30 transmits an AIS message that is a binary message including the stored local data format (S206).

On the other hand, in the case where the message to be created is a non-format message (S202: No), the AIS transmission device 30 creates a non-format message based on the local data format (S221). The AIS transmission device 30 transmits an AIS message that is the created non-format message (S206).

By using this configuration and processing, the AIS reception device 10 included in the waterborne vehicle 100 and the AIS transmission device 30 included in the base station 20 may transmit and receive AIS messages corresponding to the local data format. Furthermore, the AIS reception device 10 may utilize new local data formats without introducing equipment corresponding to the new local data formats.

### Second Embodiment

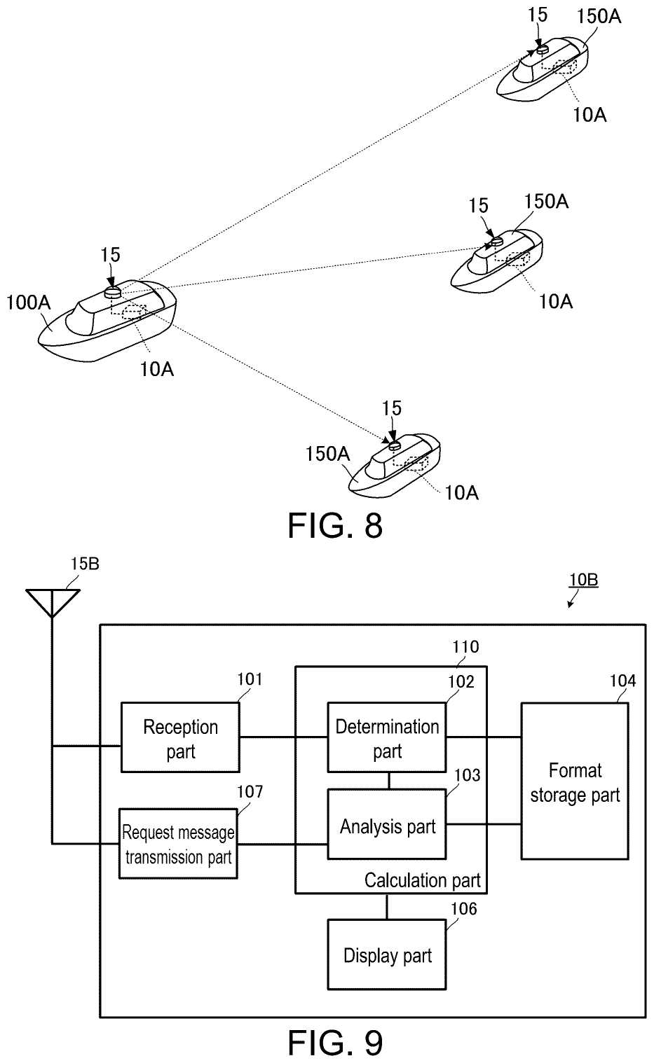

The navigation information transmission and reception system according to the second embodiment of the disclosure will be described with reference to the figures. FIG. 8 is a diagram showing an overview of message transmission and reception by a navigation information transmission and reception device included in a waterborne vehicle according to the second embodiment of the disclosure. The following description is about AIS, but it may also be applied to VDES (VHF Data Exchange System).

A waterborne vehicle 100A includes an AIS transmission and reception device 10A. The AIS transmission and reception device 10A includes both transmission and reception functions; that is, the functions of the AIS reception device 10 and the AIS transmission device 30 according to the first embodiment.

As shown in FIG. 8, the AIS transmission and reception device 10A of the waterborne vehicle 100A transmits a format message that records the local data format in the binary data of the AIS message, and the AIS transmission and reception device 10A of a waterborne vehicle 150A receives this format message. Then, the AIS transmission and reception device 10A of the waterborne vehicle 100A transmits a non-format message, and the AIS transmission and reception device 10A of the waterborne vehicle 150A receives this non-format message.

By using this configuration, binary messages may also be transmitted and received based on the local data format using the binary data of AIS messages.

In addition, while the transmission of AIS messages by the AIS transmission and reception device 10A of the waterborne vehicle 100A has been described, the AIS transmission and reception device 10A of the waterborne vehicle 150A may also transmit AIS messages. Moreover, the same applies to the reception of AIS messages. Furthermore, waterborne vehicles 150A may also transmit and receive AIS messages among themselves.

### Third Embodiment

The navigation information reception device according to the third embodiment of the disclosure will be described with reference to the figures. FIG. 9 is a functional block diagram of an AIS reception device according to the third embodiment of the disclosure. The following description is about AIS, but it may also be applied to VDES (VHF Data Exchange System).

As shown in FIG. 9, an AIS reception device 10B according to the third embodiment differs from the AIS reception device 10 according to the first embodiment in that it includes a request message transmission part 107. The other configurations of the AIS reception device 10B are the same as those in the first embodiment, and descriptions of similar parts are omitted.

As shown in FIG. 9, the AIS reception device 10B includes a reception part 101, a calculation part 110, a format storage part 104, and a request message transmission part 107. The calculation part 110 includes a determination part 102 and an analysis part 103. Additionally, the AIS reception device 10B is connected to an antenna 15B.

The request message transmission part 107 creates and transmits a transmission request message in a local format and transmits it.

In the case where a corresponding local data format is not found during the search and analysis of the format message, the calculation part 110 instructs the request message transmission part 107 to perform the transmission request of the format message of the AIS message. The request message transmission part 107 transmits the transmission request of the format message via the antenna 15B. In response to receiving the transmission request message, the AIS transmission device 30 transmits an AIS message that is a format message.

With this configuration, by making a request to transmit and receive the format message, the AIS reception device 10B may receive the desired format message in a timely manner, regardless of the format message transmission timing of the AIS transmission device 30.

### [Terms]

Not all objectives or effects/advantages described in this specification may necessarily be achieved according to any particular embodiment. Therefore, for example, those skilled in the art would recognize that specific embodiments may be configured to operate so as to achieve or optimize one or more of the effects/advantages taught or suggested in this specification without necessarily achieving other objectives or effects/advantages taught or suggested herein.

All processes described in this specification may be embodied in, and fully automated by, software code modules executed by one or more computers or processors included in a computing system. The code modules may be stored in any type of non-transitory computer-readable medium or other computer storage device. Some or all of the methods may be embodied in specialized computer hardware.

It is clear from this disclosure that there are many other variations other than those described herein. For example, depending on the embodiment, certain operations, events, or functions of any of the algorithms described herein may be performed in a different sequence, may be added, merged, or eliminated completely (e.g., not all described acts or events are necessary for the practice of the algorithm). Moreover, in certain embodiments, operations or events may be performed concurrently, e.g., through multi-threaded processing, interrupt processing, or multiple processors or processor cores or on other parallel architectures, rather than sequentially. In addition, different tasks or processes may also be performed by different machines and/or computing systems capable of functioning together.

Various illustrative logical blocks and modules described related to the embodiments disclosed herein may be implemented or performed by a machine, such as a processor. The processor may be a microprocessor but alternatively, the processor may be a controller, microcontroller, or state machine, or combinations thereof. The processor may include electrical circuitry configured to process computer-executable commands. In another embodiment, a processor includes an Application Specific Integrated Circuit (ASIC), a Field Programmable Gate Array (FPGA), or another programmable device that performs logic operations without processing computer-executable commands. The processor may also be implemented as a combination of computing devices, e.g., a combination of a digital signal processor (digital signal processing device) and a microprocessor, multiple microprocessors, one or more microprocessors in conjunction with a DSP (Digital Signal Processor) core, or any other such configuration. Although described primarily with respect to digital technology, a processor may also include primarily analog components. For example, some or all of the signal processing algorithms described herein may be implemented in analog circuitry or mixed analog and digital circuitry. A computing environment may include any type of computer system, including, but not limited to, a microprocessor, a mainframe computer, a digital signal processor, a portable computing device, a device controller, or a computer system based on a computational engine in a device.

Unless specifically stated otherwise, conditional language such as “capable of,” “can,” “might” or “may” is generally understood in the context used to convey that certain embodiments include particular features, elements and/or steps, while other embodiments do not include them. Therefore, such conditional language generally does not imply that features, elements and/or steps are necessarily required in any manner for one or more embodiments, or that one or more embodiments necessarily include logic for deciding whether these features, elements and/or steps are included or performed in any particular embodiment.

Disjunctive language such as the phrase “at least one of X, Y, or Z,” unless specifically stated otherwise, is generally understood in the context used to indicate that an item, term, etc., may be either X, Y, or Z, or any combination thereof (e.g., X, Y, and/or Z). Thus, such disjunctive language is not generally intended to imply that certain embodiments require at least one of X, at least one of Y, and at least one of Z to each be present.

Any process descriptions, elements, or blocks in the flowcharts described in this specification and/or shown in the attached drawings should be understood as potentially representing modules, segments, or portions of code which include one or more executable commands for implementing specific logical functions or elements in the process. Alternative implementations are included within the scope of the embodiments described herein in which elements or functions may be removed from that shown in figures or described substantially concurrently or in reverse order, and executed in different order depending on the functionality involved, as would be understood by those skilled in the art.

Unless explicitly stated otherwise, numerical terms such as “one” should generally be interpreted to include one or more of the described items. Therefore, phrases such as “one device configured to . . . ” are intended to include one or more of the listed devices. Such one or more listed devices may also be collectively configured to perform the described recitations. For example, “a processor configured to perform the following A, B, and C” may include a first processor configured to perform A and a second processor configured to perform B and C. In addition, even if a specific number of examples introduced is explicitly enumerated, those skilled in the art should interpret that such enumeration typically means at least the enumerated number (e.g., the mere recitation of “two enumerations” without other modifiers typically means at least two enumerations, or two or more enumerations).

In general, the terms used in this specification are generally understood by those skilled in the art to be intended as “non-limiting” terms (e.g., the term “include” should be interpreted as “not only . . . but at least include,” the term “have” should be interpreted as “have at least,” and the term “include” should be interpreted as “include the following but not limited thereto” etc.).

For the purpose of explanation, the term “horizontal” as used in this specification is defined as a plane parallel to the plane or surface of the floor of the area in which the described system is used, or the plane in which the described method is performed, regardless of its orientation. The term “floor” may be replaced with the terms “ground” or “water surface”. The term “vertical/perpendicular” refers to a direction normal/perpendicular to the defined horizontal line. Terms such as “upper”, “lower”, “below”, “above”, “side”, “higher”, “lower”, “upward”, “over”, “under”, etc. are defined in relation to the horizontal plane.

The terms “attach”, “connect”, “couple”, and other related terms as used in this specification should be interpreted to include removable, movable, fixed, adjustable, and/or detachable connections or couplings, unless otherwise noted. The connection/coupling includes direct connections and/or connections having intermediate structures between the two described components.

Unless explicitly stated otherwise, terms such as “approximately”, “about”, and “substantially” preceding a number as used in this specification include the enumerated number and also represent quantities close to the stated amount that perform the desired function or achieve the desired result. For example, “approximately”, “about”, and “substantially” refer to values less than 10% of the stated numerical value, unless explicitly stated otherwise. As used in this specification, embodiments disclosed with terms such as “approximately”, “about”, and “substantially” preceding them represent features that have some variability that further perform the desired function or achieve the desired result for that feature.

Many modification examples and modifications may be added to the above-described embodiments, and their elements should be understood to be among other acceptable examples. All such modifications and variations are intended to be included within the scope of this disclosure and are protected by the following claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A navigation information reception device, comprising:
a receiver configured to receive a navigation information message; and
processing circuitry configured to:
determine whether the received navigation information message is a format message or a non-format message;
store format information included in the navigation information message in a case where the received navigation information message is determined to be the format message; and
analyze content of the navigation information message based on the stored format information in a case where the received navigation information message is determined to be the non-format message and where the format information is stored.

2. The navigation information reception device according to claim 1,
wherein the format information is a local data format agreed upon for exchanging information within a specific region.

3. The navigation information reception device according to claim 1,
wherein the processing circuitry stores new format information in a case where the stored format information differs from the new format information included in the newly received navigation information message.

4. The navigation information reception device according to claim 2,
wherein the processing circuitry stores new format information in a case where the stored format information differs from the new format information included in the newly received navigation information message.

5. The navigation information reception device according to claim 1,
wherein the processing circuitry is further configured to:
transmit a transmission request message for the corresponding format message in a case where the format information corresponding to the received non-format message is not stored.

6. The navigation information reception device according to claim 2,
wherein the processing circuitry is further configured to:
transmit a transmission request message for the corresponding format message in a case where the format information corresponding to the received non-format message is not stored.

7. The navigation information reception device according to claim 3,
wherein the processing circuitry is further configured to:
transmit a transmission request message for the corresponding format message in a case where the format information corresponding to the received non-format message is not stored.

8. The navigation information reception device according to claim 1, further comprising:
a display configured to display the non-format message analyzed by the processing circuitry.

9. The navigation information reception device according to claim 1,
wherein the navigation information message is a binary message of an AIS message.

10. The navigation information reception device according to claim 2,
wherein the navigation information message is a binary message of an AIS message.

11. The navigation information reception device according to claim 3,
wherein the navigation information message is a binary message of an AIS message.

12. The navigation information reception device according to claim 6,
wherein the processing circuitry determines based on a message identifier included in the binary message.

13. The navigation information reception device according to claim 6,
wherein the processing circuitry determines based on an identifier included in a binary data part of the binary message.

14. A navigation information transmission device, comprising:
processing circuitry configured to:
store format information included in a format message; and
create a navigation information message comprising a format message including the format information, and a navigation information message comprising a non-format message recorded based on the format information; and
a transmitter configured to transmit respectively the navigation information message comprising the format message and the navigation information message comprising the non-format message.

15. The navigation information transmission device according to claim 9,
wherein the transmitter periodically transmits the navigation information message comprising the format message.

16. A navigation information transmission and reception system, comprising:
a navigation information reception device, comprising:
a receiver configured to receive a navigation information message;
processing circuitry configured to:
determine whether the received navigation information message is a format message or a non-format message;
store format information included in the navigation information message in a case where the received navigation information message is determined to be the format message; and
analyze content of the navigation information message based on the stored format information in a case where the received navigation information message is determined to be the non-format message and where the format information is stored; and
the navigation information transmission device according to claim 9,
wherein the navigation information reception device receives the navigation information message transmitted by the navigation information transmission device.

17. The navigation information transmission and reception system according to claim 11,
wherein the navigation information reception device is to be installed on a ship.

18. The navigation information transmission and reception system according to claim 11,
wherein the navigation information transmission device is to be installed on a land-based base station or a ship.

19. A navigation information reception method, comprising:
receiving a navigation information message;
determining whether the received navigation information message is a format message or a non-format message;
storing format information included in the navigation information message in a case where the received navigation information message is determined to be the format message; and
analyzing content of the non-format message based on the format information in a case where the received navigation information message is determined to be the non-format message and where the format information is stored.

20. A navigation information transmission method, comprising:
storing format information included in a format message;
creating a navigation information message comprising the format message recording the format information, and a navigation information message comprising a non-format message recorded based on the format information; and
transmitting respectively the navigation information message comprising the format message and the navigation information message comprising the non-format message.
